(19) United States
(12) Patent Application Publication
(10) Pub. No.: US 2009/0032761 A1
(43) Pub. Date: Feb. 5, 2009

(54) SPHERICAL VALVE

(76) Inventor: CHI-LUNG TSAI, Lingya Area (TW)

Correspondence Address: J.C. Patents;Suite 250, 4 Venture, Irvine, CA, 92618, US

(21) Appl. No.: 11/830,702

(22) Filed: Jul. 30, 2007

(51) Int. Cl. F16K 5/06

(52) U.S. Cl. 251/315.1

(57) ABSTRACT

This invention has an objective of offering a spherical valve, which has a valve chamber with a space enough for receiving a valve therein, and letting the valve move smoothly therein. A connecting member respectively formed at two sides of the valve chamber is for connecting with exterior tubes, having an annular projecting portion with a comparatively large thickness so that shrinking occurring during inject-forming process of the body may be offset by the annular projecting portions so that the valve chamber may not be deformed so that the valve may move smoothly in the valve chamber.

### BACKGROUND OF THE INVENTION

1. Field of the Invention

This invention relates to a spherical valve, particularly to one having a valve properly combined in a valve chamber of a body, and the body has a connecting member at two sides of the valve chamber and formed with an annular projecting portion for absorbing natural shrinkage at the time of inject-forming the body in the mold, so the valve chamber may have a preset space as previously designed, letting the valve placed therein may have enough room for smooth movement in opening and closing the spherical valve.

2. Description of the Prior Art

A conventional spherical valve disclosed in a U.S. Pat. No. 7,108,243 B2 includes a body 1, a valve chamber 10 formed in the body 1, and a valve 2 placed in the valve chamber 10. The valve chamber 10 is surrounded by an annular wall 100, and an anti-leak O-shaped gasket 101 fitted at two sides of the annular wall 100, a connecting member 11 formed at two sides of the valve chamber 10 for connecting with a tube respectively, one of the connecting member formed with an inlet 110, the other of the connecting members formed with an exit 111. In order to let the valve chamber 10 connected smoothly with the connecting members 11, the intermediate portion of the annular wall 100 has a thinnest thickness (d) and then the thickness (d1) of the two sides of the annular wall 100 largest. So the connecting members 11 may look smooth and the material for the body 1 may be swiftly sent into the mold. The shape of the cavity in a male and female mold is the shape of the body 1 after the body is formed, and the mold cannot be opened until the material in the mold cools down. And the cooling speed depends on the thickness of the product, and it is rather quick in case of small thickness, and rather slow in case of large thickness. In cooling, it starts from the outer portion and gradually moves to the inner portion, so if the wall is comparatively thick, chances are that the mold may be opened even if the inner portion does not still cool down enough and a product may be taken out of the mold. Then shrinking phenomenon may occur to make the outer surface look rough and not smooth, depending on the condition of the environment. Therefore, it may affect the size of the space of the valve chamber 10, as the thicker outer portion (D1) of the annular wall 100 may have the shrinking phenomenon, and subsequently the sized of the space of the valve chamber may not be formed as preset designed, causing the valve 2 impossible to move around freely in the valve chamber 10 so that the finished product is not qualified.

### SUMMARY OF THE INVENTION

The invention has been devised to offer a spherical valve provided with a valve chamber having a proper space for a valve to move smoothly therein.

The feature of the spherical valve is that the valve is placed in advance in a mold, which the body of the spherical valve is formed, so the valve chamber may have a space as preset designed for the valve to move smoothly for opening and closing the spherical valve. The spherical valve in the invention has the following characteristics.
1. It is provided with a valve chamber in a body for receiving a valve therein, and an annular wall defining the valve chamber and having an even thickness.
2. It is provided with a connecting member respectively at two sides of the valve chamber for connecting with an exterior tube, and one of the two connecting members having an inlet and the other having an outlet for liquid. The connecting members are further provided with an annular projecting portion having a thicker wall than the annular wall of the valve chamber.
3. The annular projecting portion of the connecting members can absorb shrinking during inject-forming the body so that the valve chamber may have a proper space for the valve to move smoothly for opening and closing the spherical valve.

### BRIEF DESCRIPTION OF DRAWINGS

This invention will be better understood by referring to the accompanying drawings, wherein:

FIG. 1 is a cross-sectional view of a conventional spherical valve;

FIG. 2 is a side view of a spherical valve in the present invention;

FIG. 3 is a cross-sectional view of a line A-A in FIG. 3; and,

FIG. 4 is a perspective view of the spherical valve in the present invention.

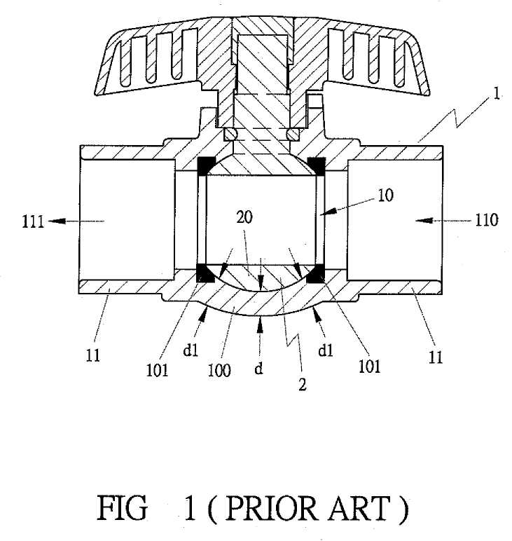

### DETAILED DESCRIPTION OF THE PREFERRED EMBODIMENT

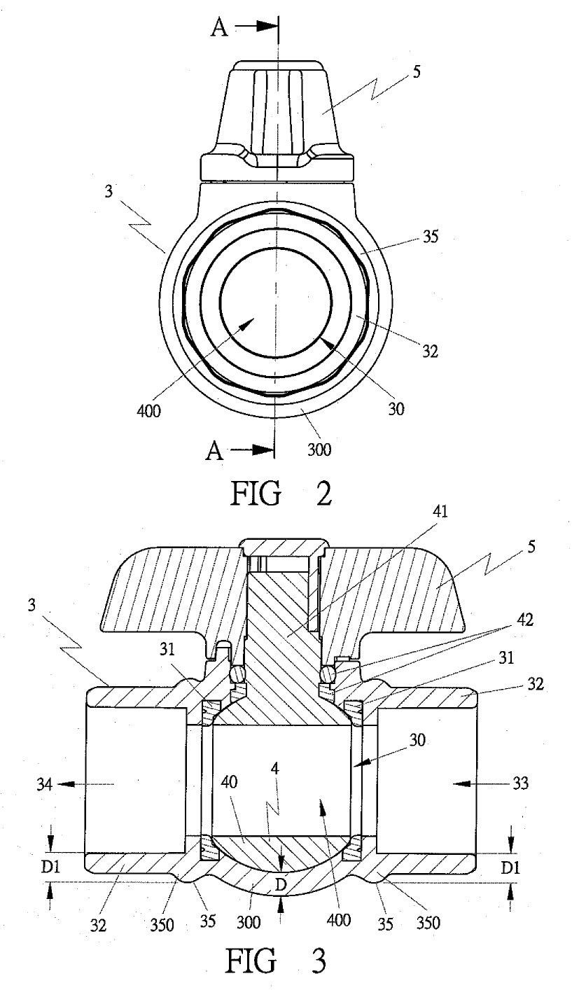

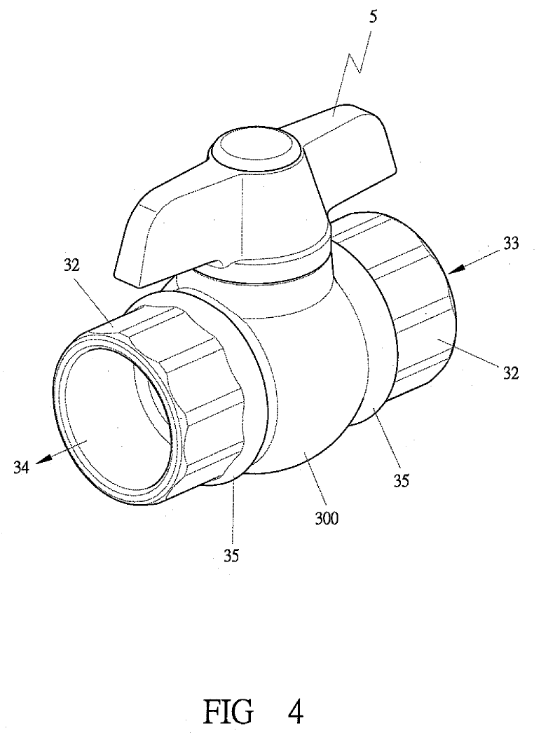

A spherical valve in the present invention, as shown in FIGS. 2, 3 and 4, includes a body 3, and a valve 4 as main components.

The body 3 is made integral, provided with a valve chamber 30 defined by an annular wall 300 of an even thickness (D) or permissible small difference in some portion of the annular wall 300, an anti-leak O-shape gasket 31 fitted at two connecting locations of the valve chamber 30 and two connecting members 32 respectively, for preventing liquid flowing through the spherical valve from leaking. The two connecting members 32 connect with exterior tubes and formed with an inlet 33 and an exit 34 respectively. The two connecting members 32 respectively have an annular projecting portion 35 at an inner side adjacent to the valve chamber 30 with its wall 350 having a thickness (D1) thicker than that (D) of the annular wall 300 so that the annular projecting portion 35 may cool down a little more quickly than the annular wall 300, and then the annular wall 300 may cool down with a definite speed. In case that shrinking phenomenon occurs during forming the body, it occurs in the direction of the annular projecting portion 35, enabling the valve chamber to have the preset size of a space as designed and the valve to move therein smoothly for opening and closing the spherical valve.

The valve 4 has a valve body 40 and a shaft 41, and the valve body 40 is provided with center hole 400 facing to the inlet 33 and the exit 34 for liquid to flow through. The shaft 41 extends upward from the body 40 and formed integral with the valve body 40. Further, a handle 5 is provided to combine with an upper portion of the shaft 41 for turning the shaft 41 together with the valve body 40 to stop liquid in the spherical valve from flowing through.

Next, before forming the body 3 in the mold, the valve 4 has to be placed in the mold in advance, and in the process of inject-forming the body 3 the valve 4 is to be located in the valve chamber 30 of the body 3, and the annular projecting portion 35 of the connecting members 32 has to be formed as designed, permitting the valve 4 to move smoothly in the space of the valve chamber 30 for opening and closing the spherical valve. The main characteristic of the spherical valve in the invention is different thickness of the walls of the annular wall 300 and the connecting members 32 for cooling down with different speed, with the annular projecting portion 35 of the connecting members 32 provided for absorbing enough the shrinking phenomenon, permitting the most desirable condition of the relation of the valve 4 with the valve chamber 30, reducing unqualified finished products.

While the preferred embodiment of the invention has been described above, it will be recognized and understood that various modifications may be made therein and the appended claims are intended to cover all such modifications that may fall within the spirit and scope of the invention.

What is claimed is:

1. A spherical valve comprising:
a body provided with a valve chamber defined by an annular wall, said annular wall having an even thickness, a connecting member provided at two sides of said valve chamber respectively, said connecting members respectively connected with an exterior tube and having an inlet and an exit for liquid to flow through, said connecting members provided with an annular projecting portion with a comparative thickness;
A valve having a valve body and a shaft, said valve body provided with a through hole possible to communicate with said inlet and said outlet of said connecting members of said body, said shaft extending up from said valve body and combined with a handle on an upper end.

2. The spherical valve as claimed in claim 1, wherein said annular wall has a permissible difference in its thickness.

3. The spherical valve as claimed in claim 1, wherein said annular wall of said valve chamber has a thickness (D) smaller than a thickness (D1) of a wall of said annular projecting portion
